(19) United States
(12) Patent Application Publication
(10) Pub. No.: US 2008/0288709 A1
(43) Pub. Date: Nov. 20, 2008

(54) Wide area network connection platform

(75) Inventors: Andrew Stanley-Jones, Tippecanoe, IN (US); Scott Allan Yoder, Syracuse, IN (US); Jon Channing Utter, Bourbon, IN (US)

Correspondence Address: BAKER & DANIELS LLP, 300 NORTH MERIDIAN STREET, SUITE 2700, INDIANAPOLIS, IN, 46204, US

(73) Assignee: ImageStream Internet Solutions, Plymouth, IN (US)

(21) Appl. No.: 11/798,628

(22) Filed: May 15, 2007

(51) Int. Cl. G06F 13/20

(52) U.S. Cl. 710/313

(57) ABSTRACT

Embodiments of the invention relate to a wide area network platform for use in conjunction with multiple distinct bus applications. The wide area network platform may include a hardware module for connection with system hardware, the hardware module including a universal serial bus interface and a wide area network interface. The hardware module is operable with multiple distinct bus applications. The platform may further include a universal device driver for interfacing with an operating system and with the system hardware and operating transparently through the multiple distinct bus applications.

### RELATED APPLICATION DATA

This application is related to U.S. patent application Ser. No. 11/713,043, filed on Mar. 2, 2007, which is hereby incorporated by reference.

### TECHNICAL FIELD

Embodiments of the present invention relate to a platform for connecting a computing device or system with a wide area network (WAN). In particular, embodiments of the invention pertain to the uniform use of a single universal driver with an adaptable line interface card across multiple bus architectures.

### BACKGROUND OF THE INVENTION

WANs are used to connect local area networks (LANs) and other types of networks together so that users and computers in one location can communicate with users and computers in other locations. The typical WAN interface card that allows devices to connect to a WAN is a standard-sized circuit card that fits into a router expansion slot. Generally, different WAN cards are manufactured for use with each of the common network protocols.

WAN cards are utilized in many different system configurations. The systems can be very small or can be large embedded systems or large routers. For example, a WAN card may be utilized with a small home router, such as a wireless home networking router manufactured by D-link, or in large scale equipment at a telephone company. Depending on the type of system, buses through which data is transmitted tend to change due to the rate and quantity of data transfer required as well as other factors.

WAN interface cards have traditionally been designed to work with one type of system bus. Most recently, multiple bus standards requiring different WAN interface cards have evolved. Some bus standards include peripheral component interconnects (PCI) and its electrical equivalents such as PCI Mezzanine Card (PMC), CompactPCI, and MiniPCI. Additionally, various different bus standards such as PCI Express and Advanced TCA, are becoming more commonplace.

Unfortunately as bus standards evolve, various different bus standards involve significant electrical changes and require new WAN interface cards to be designed. The requirement for designing new cards adds to inventory requirements, manufacturing costs, etc. Additionally, on embedded systems, some types of buses, such as PCI busses, are not always available since they tend to consume excessive space, have many lines, and are rather expensive. Thus, when buses change, software, such as drivers, tends to change and the configuration of required hardware, such as WAN cards also requires changes. These changes to software and hardware are time consuming, cause duplication, and increase costs.

Although system configurations may change, the primary function of the hardware platform is simply to transport data in both directions. Accordingly, the process is greatly simplified if the same driver can be used regardless of the system configuration. Accordingly, a solution is needed that facilitates the use of a single identical driver for different types and scales of systems. A solution is also needed that provides for a universal or adaptable WAN card to run in telecommunications systems, embedded systems, or in common PC hardware with different types of buses and a single driver. Ideally, the solution should work transparently with any bus architecture.

### BRIEF SUMMARY OF THE INVENTION

In one aspect, a WAN platform is provided for use in conjunction with multiple distinct bus applications. The WAN platform includes a hardware module for connection with system hardware. The hardware module includes a USB interface and a WAN interface and is operable with multiple distinct bus applications. The WAN platform additionally includes a universal device driver for interfacing with an operating system and with the system hardware and operating transparently through the multiple distinct bus applications.

In another aspect, a method is provided for connecting a system with a wide area network. The method includes providing a hardware module for connection with system hardware, the hardware module including a universal serial bus interface and a wide area network interface and connecting the hardware module with multiple distinct bus configurations. The method additionally includes providing a universal line card device driver for use with the hardware module and the multiple distinct bus configurations

In yet a further aspect of the invention, a line interface card is provided for connecting a system with a wide area network. The line interface card includes a USB interface. The USB interface may include a double USB connector. The double USB connector has a first USB connection parallel to a surface of the line interface card and a second USB connection perpendicular to the surface of the line interface card. The line interface card further includes at least three mounting holes for allowing the line interface card to be mounted to a carrier card.

### BRIEF DESCRIPTION OF THE DRAWINGS

The present invention is described in detail below with reference to the attached drawings, wherein:

FIG. 1 is a block diagram illustrating a router in accordance with an embodiment of the invention;

FIG. 2 is a block diagram illustrating components of device driver associated with the router in accordance with an embodiment of the invention;

FIG. 3A is a block diagram illustrating a router configuration in accordance with an embodiment of the invention;

FIG. 3B is a block diagram illustrating a router configuration in accordance with an alternative embodiment of the invention;

FIG. 3C is a block diagram illustrating a router configuration in accordance with a further alternative embodiment of the invention;

FIG. 4 is perspective view of a line interface card in accordance with an embodiment of the invention;

FIG. 5 is a perspective view of a line interface card on a PCI carrier in accordance with an embodiment of the invention;

FIG. 6 is a perspective view illustrating a line interface card in an embedded system in accordance with an embodiment of the invention; and

FIG. 7 is a perspective view showing a line interface card on a PCI bus in accordance with an embodiment of the invention.

### DETAILED DESCRIPTION OF PREFERRED EMBODIMENTS

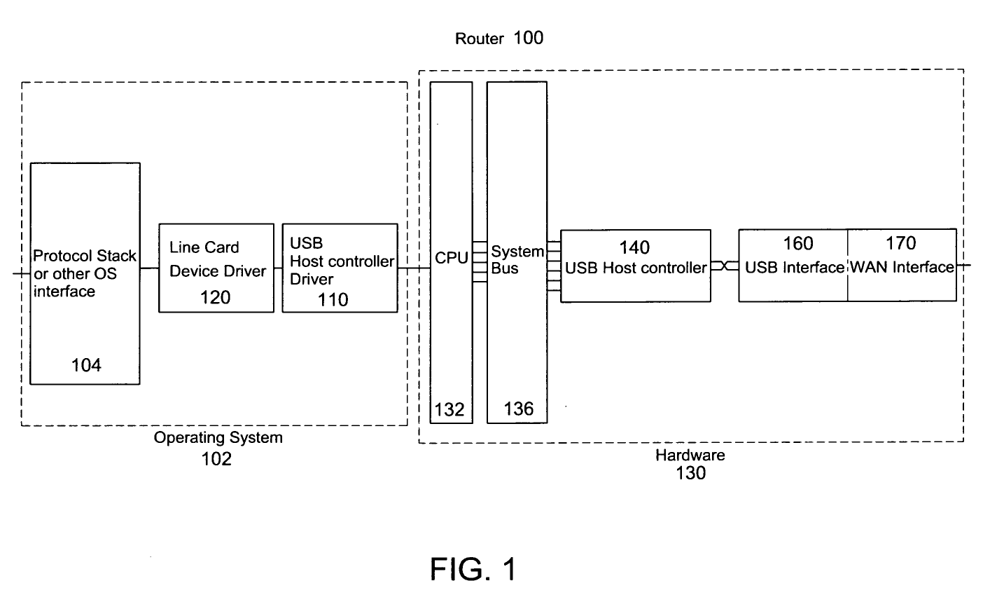

FIG. 1 is a block diagram illustrating components of a router 100 in accordance with an embodiment of the invention. The components shown may be disposed within or operatively connected with a router 100 through which data is received and transmitted. The router may function as customer premise equipment (CPE). CPE is telephone or other service provider end-user equipment that is located on the customer's premises or physical location rather than on the provider's premises or in between. Telephone handsets, cable TV set-top boxes, and digital subscriber line routers are examples of CPE. In alternative embodiments, the components may be located in or connected with a router at network operation center. The network operation center may, for example, connect with multiple data lines from outside sources. The displayed components would be available to interconnect data flow between service providing companies and main network links.

An operating system (OS) 102 may include a protocol stack or other OS interface 104, a line card device driver 120, and a universal serial bus (USB) host controller driver 110. Hardware 130 may include a central processing unit (CPU) 132, a system bus 136, a USB host controller 140, and a line interface card 150. The line interface card 150 may include a USB interface 160 and a WAN interface 170.

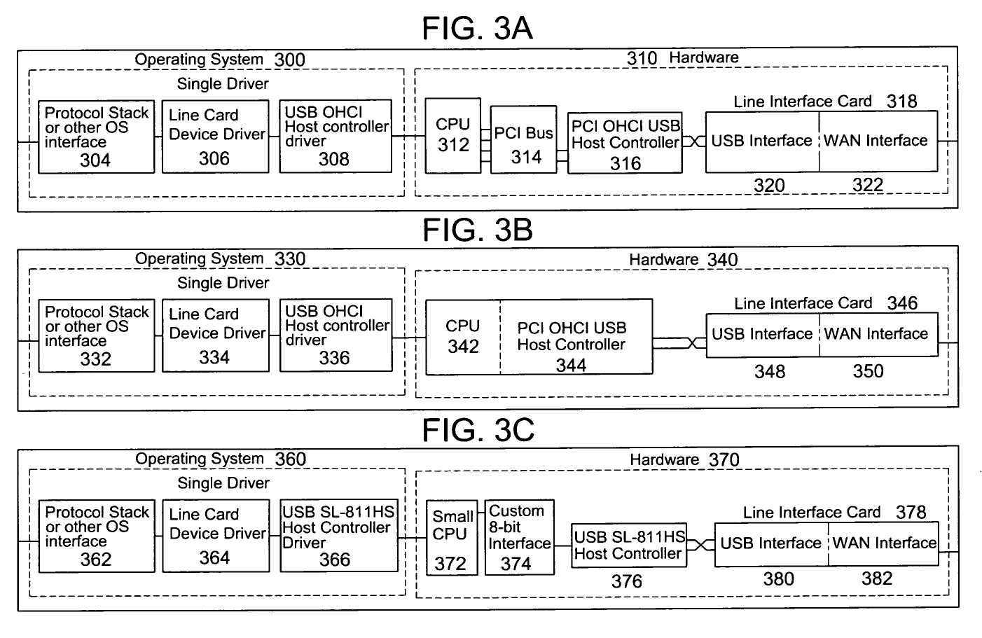

Of the displayed components, the line interface card 150 and the line card device driver 120 form a WAN platform that remains constant across multiple bus architectures. The other displayed components may vary based on the system architecture. These variations will be more fully explained below with respect to FIGS. 3A-3C. The line interface card 150 is flexible, inexpensive, and easily interchangeable at both the protocol level and the physical line interface. Aspects of the line interface card are described in detail in U.S. patent application Ser. No. 11/713,043, filed on Mar. 2, 2007, which is incorporated herein by reference.

The line interface card 150 may include the USB interface 160 and the WAN interface 170. The WAN interface 170 may include a flexible protocol engine (FPE) and line interface (LI), both described in detail in the aforementioned patent application. The LI may change on each version of the interface card to support different physical interfaces such as T1/E1/SSI, DS3 and HSSI. Changes to the LI may be accomplished without major hardware changes to the remainder of the board. The FPE hardware remains the same in each hardware layout with the exception of minor changes required to interface with the LI. The FPE is a field programmable gate array (FPGA) which requires programming to operate every time it is powered on. The FPGA can be reprogrammed as needed. Firmware operating in the FPE can be changed and updated as needed to support different protocols.

With regard to the USB interface 160, USB offers several advantages as an interface to the line interface card 150 and provides a common software and hardware interface standard. USB works up to rates of 480 mbit/sec, which is fast enough for most physical interfaces including at least T3 or OC1 physical interfaces. USB interfaces are available for PCI, PCI Express, and other known interfaces. Embedded systems frequently have a local USB interface on die. For USB 2.0, the hardware interface standard is called the extended host controller interface (EHCI) and for earlier USB versions, it is either universal host controller interface (UHCI), or open host controller interface (OHCI).

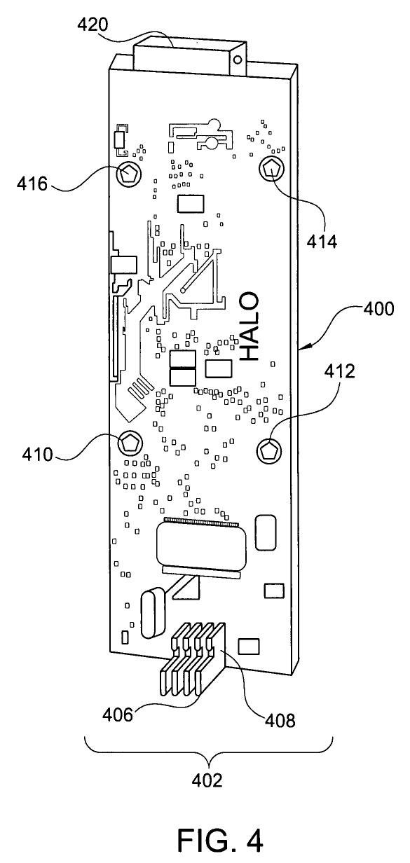

This common USB interface 160 allows the USB line interface card 150 to interface with the single driver 120, and provides a single hardware interface that works on embedded interfaces, PCI buses, PCI express, and other bus standards. The line interface card 150 is designed such that it can be mounted onto a carrier card as will be further explained below with respect to FIG. 4. Thus, to interface to a PCI bus, a carrier card is designed that interfaces from PCI to USB. PCI USB chips, which are known and commercially available, are available for conversion between PCI and USB and the reference design can be used. In embodiments of the invention, the WAN can simply plug into the carrier card, thereby rendering the line interface card 150 a PCI WAN card.

For a PCI express line interface card, a carrier card can use a PCI express USB chip for translation between USB and PCI express, which is also known and commercially available. Upon attachment of the carrier card to the line interface card 150, a PCI express WAN card is created. Since USB provides a common software interface for drivers, the PCI express WAN card uses the exact same single drivers as the PCI card or the embedded system.

Thus, in the displayed embodiment, regardless of the type and scale of the router 100, the same line card device driver 120 may be implemented. The line card device driver 120 passes data to and from the OS interface 104. The line card device driver 120 is portable and may be used in a variety of systems.

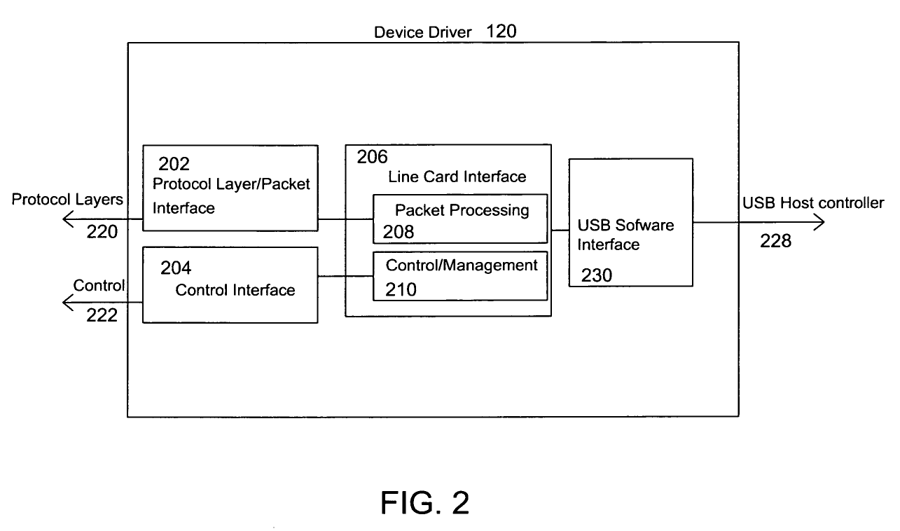

FIG. 2 is a block diagram illustrating particular features of the device driver 120 in accordance with an embodiment of the invention. The line card device driver 120 may include a protocol layer/packet interface 202, a control interface 204, a line card interface 206, and a USB software interface 230. The line card interface 206 may include a packet processing module 208 and a control/management module 210. The line card interface 206 takes data it receives from the USB software interface 230. The packet processing module 208 and control/management module 210 interpret the received data and separate the data into packets, control information, error checks, etc. The data is then passed to the protocol layer/packet interface 202 and the control interface 204. The protocol layer/packet interface 202 interfaces with protocol layers at 220 and the control interface 204 interfaces with controls at 222. The USB software interface 230 interfaces with the USB host controller at 228. As will be further explained with respect to FIGS. 3A-3C, the host controller 228 may vary, but the USB software interface 230 remains the same across multiple system configurations.

The structure of the device driver 120 enables it to be used across all bus architectures. The USB software interface 230 enables communication with a USB host controller and provides a common software interface across all bus architectures. A different device driver will not be required unless a different operating system is introduced. However, for each operating system, only one device driver will be needed to support different buses.

FIGS. 3A-3C illustrate multiple embodiments of the WAN platform. FIG. 3A illustrates an example of the WAN platform with the use of a PCI bus 314. An operating system 300 includes a protocol stack or other OS interface 304, a line card device driver 306, and a USB EHCI controller 308. Hardware 310 includes a CPU 312, the PCI Bus 314, a PCI ECHI USB Host controller 316, and a line interface card 318. The line interface card 318 may include a USB interface 320 and a WAN interface 322.

To interface to a PCI bus, a carrier card may be designed that interfaces from PCI to USB. PCI USB chips, which are known and commercially available, are available for conversion and the reference design can be used. In embodiments of the invention, the WAN can simply plug into the carrier card, thereby rendering the line interface card 150 a PCI WAN card.

FIG. 3B illustrates an example of a WAN platform for an embedded CPU. An operating system 330 may include a protocol stack or other OS interface 332, a line card device driver 334, and a USB OHCI host controller driver 336. Hardware 340 may include a CPU 342, an OHCI USB Host controller 344, and a line interface card 346. The line interface card 346 may include a USB interface 348 and a WAN interface 350.

FIG. 3C illustrates an 8 bit bus interface WAN platform in accordance with an embodiment of the invention. An operating system 360 may include a protocol stack or other OS interface 362, a line card device driver 364, and a USB SL-811HS Host controller driver 366. Hardware 370 may include a small CPU 372, a custom 8 bit interface 374, a USB SL-811HS Host controller 376, and a line interface card 378. The line interface card 378 may include a USB interface 380 and a WAN interface 382.

Thus, as shown in FIGS. 3A-3C, system components may vary. However, the respective line card device drivers 336, 334, and 364 may be identical to one another. Each of these line card device drivers 306, 334, and 364 includes a USB software interface 230 as illustrated in FIG. 2. Furthermore, the respective line interface cards 318, 346, and 378 also remain unchanged across the different systems. As illustrated, each line interface card includes a USB interface and a WAN interface. The line interface cards are physically configured to attach carrier cards that may include conversion chips.

FIG. 4 is perspective view of a line interface card in accordance with an embodiment of the invention. A line interface card 400 may include four mounting holes 410, 412, 414, and 416 that may be utilized to attach the line interface 400 to a carrier card if a carrier card is necessary. Other alternative or additional mounting structures may also be provided. Carrier cards may be necessary when a conversion chip is required. A double USB connector 402 may include a connector 406 parallel to the line interface card 400 and a USB connecter 408 disposed perpendicularly to the line interface card 400. The perpendicular USB connector 402 facilitates connection with a carrier card when such connection is necessary, for example when a conversion chip is needed. The parallel connector 406 facilitates mounting in embedded systems when no carrier card is required. Perpendicular connectors are generally too tall to provide this connection. While this double USB connector 402 represents one preferred embodiment, other preferred embodiments are also within the scope of the invention. The line interface card 400 may additionally include an interface 420. Other displayed features of the line interface card 400 not labeled or described herein may be construed as known line interface card features.

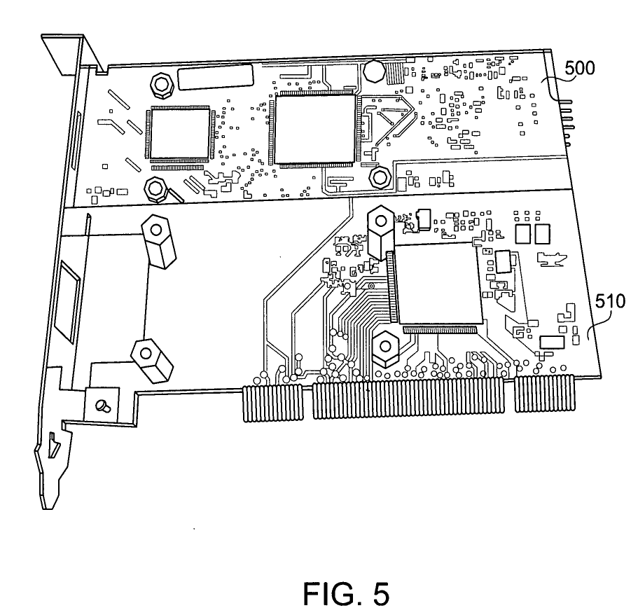

FIG. 5 is a perspective view of a line interface card on a PCI carrier card in accordance with an embodiment of the invention. A line interface card 500 is mounted on a carrier card 510. In the PCI example, the carrier card contains a generic USB to PCI bus conversion chip.

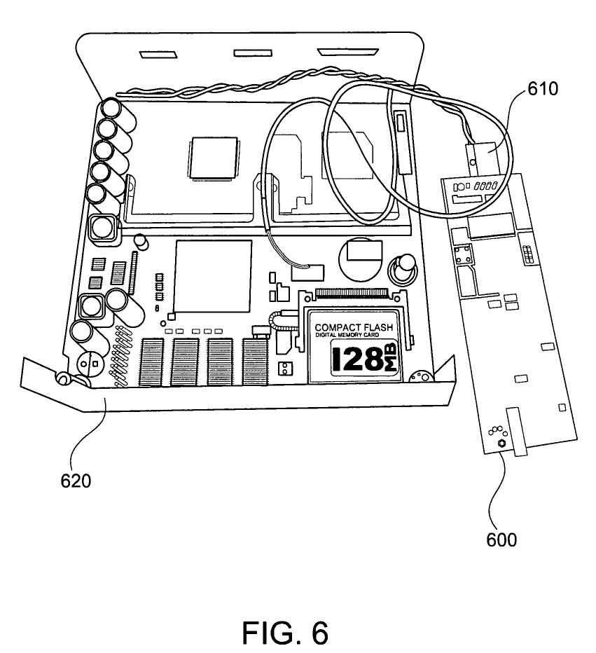

FIG. 6 is a perspective view illustrating a line interface card in an embedded system in accordance with an embodiment of the invention. A line interface card 600 is connected with an embedded system 620 through connectors 610. Embedded systems often include USB built into a core of the main board. Thus, the line interface card 600 plugs into the USB interface and communicates with it using the USB software interface. Since USB is built into the core of the main board, a carrier card would not be necessary.

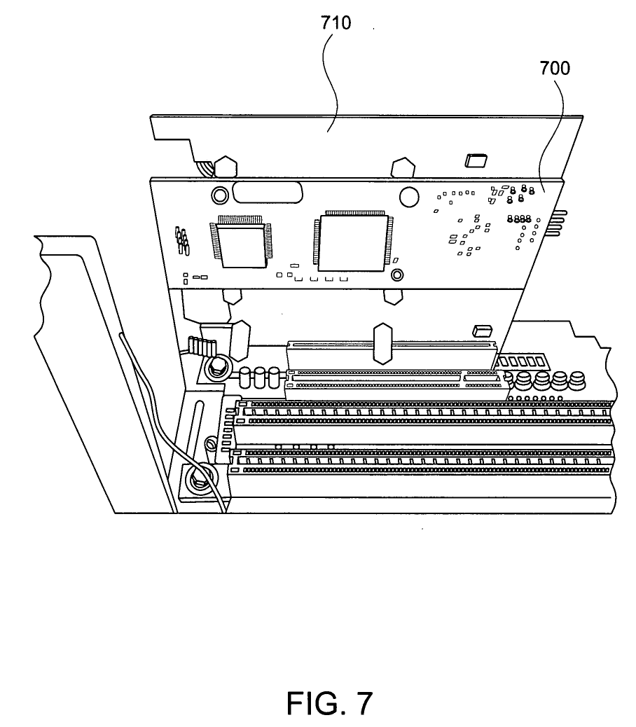

FIG. 7 is a perspective view showing a line interface card on a PCI bus in accordance with an embodiment of the invention. A line interface card 700 may be mounted to a PCI bus 710. From an operating system perspective, most operating system have a standard technique for communicating with USB controllers such as a generic interface driver that communicates with a PCI host controller.

In a preferred embodiment, the line interface cards shown in FIGS. 4-7 are provided with dimensions that facilitate mounting. For example, the line interface card may be approximately forty millimeters wide and one hundred twenty millimeters long. These dimensions allow two line interface cards to be mounted on a half length PCI card, which has a maximum length of one hundred seventy five millimeters. Furthermore, the line interface card preferably has a height of less than seventeen millimeters to facilitate mounting in PCI carrier cards or thin systems.

The WAN platform including the line interface card and the single USB device driver has many advantages. For example, the common hardware modules use USB to minimize costs in terms of board size, logic, and pin count. The platform also makes it possible to achieve larger economies of scale, not only because a common WAN module is used across multiple buses, but also because a common carrier card for each bus will support any of the different WAN platforms.

The platform provides universal device driver software that works transparently with any bus architecture. Each WAN module includes a USB interface that is natively supported by all modern operating systems. Whether the operating system is Linux, Windows, or another OS, the USB interface to each WAN module provides a universal hardware interface to the OS, so that a single device driver can be used for native USB bus operation, or in tandem with native OS support for other buses.

Thus with one operating system, a single driver may be maintained with various interfaces to talk to the one line card. In summary, the disclosed WAN platform design implements a common hardware module with one USB port and one WAN interface. The common hardware module or line interface card can be used in stand-alone USB applications, or it can be deployed in PCI, PCI Express, and alternative bus applications using the appropriate carrier card.

Furthermore, the WAN platform provides universal device driver software that works transparently with any bus architecture. Each WAN module includes a USB interface that is natively supported by all modern operating systems such as Linux, Windows, or other OS. The USB interface to each WAN module provides a universal hardware interface to the OS, so a single device driver can be used for native USB bus operation, or in tandem with native OS support for other buses.

In this context, different device drivers will be required to support different operating systems, but only one driver will ever be needed to support different buses under one OS. This strategy not only simplifies driver development, but also expands the number of embedded applications that are supported by a single development or integration effort. The work required to support PCI cards also supports USB and PCI Express applications. Thus, the disclosed WAN cards can be integrated into PCI applications, and the same hardware modules and device drivers can be deployed in USB and PCI Express applications with no additional development.

Other network cards may include PCI and PMC support in a single device driver, but both are the PCI at the driver level. With the disclosed WAN platform, USB is used as the common bus, which makes it possible to deploy WAN modules across multiple bus architectures using a single driver specification.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A wide area network platform for use in conjunction with multiple distinct bus applications, the wide area network platform comprising:
a hardware module for connection with system hardware, the hardware module including a universal serial bus interface and a wide area network interface, wherein the hardware module is operable with the multiple distinct bus applications; and
a universal device driver for interfacing with an operating system and with the system hardware and operating transparently through the multiple distinct bus applications.

2. The wide area network platform of claim 1, wherein the hardware module comprises a line interface card.

3. The wide area network platform of claim 2, wherein the line interface card comprises at least one universal serial bus connector.

4. The wide area network platform of claim 1, further comprising means for connecting with a carrier card.

5. The wide area network of claim 1, further comprising means for connecting with an embedded system.

6. The wide area network platform of claim 1, wherein the universal device driver comprises a line card interface and a universal serial bus software interface.

7. The wide area network platform of claim 1, further comprising a carrier card, wherein the hardware module is mountable on the carrier card.

8. The wide area network platform of claim 7, wherein the carrier card comprises a universal serial bus conversion chip.

9. A method for connecting a system with a wide area network, the method comprising:
providing a hardware module for connection with system hardware, the hardware module including a universal serial bus interface and a wide area network interface;
connecting the hardware module with multiple distinct bus configurations; and
providing a universal line card device driver for use with the hardware module and the multiple distinct bus configurations.

10. The method of claim 9, further comprising implementing the hardware module with at least one universal serial bus connector.

11. The method of claim 9, further comprising connecting the hardware module with a carrier card.

12. The method of claim 9, further comprising connecting the hardware module with an embedded system.

13. The method of claim 9, further comprising providing means for mounting the hardware platform to a carrier card.

14. The method of claim 9, further comprising providing the universal device driver with a universal serial bus software interface.

15. The method of claim 9, further comprising mounting the hardware module to a carrier card having a universal serial bus conversion chip.

16. A wide are network platform including a line interface card for connecting a system with a wide area network, the line interface card comprising:
at least one universal serial bus interface for allowing connection with a carrier card and an embedded system; and
mounting means for allowing the line interface card to be mounted to a carrier card.

17. The wide area network platform of claim 16, wherein the carrier card comprises a universal serial bus conversion chip.
